(19) United States
(12) Patent Application Publication
(10) Pub. No.: US 2008/0029034 A1
(43) Pub. Date: Feb. 7, 2008

(54) Method and apparatus for automatic feeding of animals

(76) Inventors: Matthew Busbice, Lafayette, LA (US); Ron Ferguson, Ingram, TX (US)

Correspondence Address: Ted M. Anthony, Suite 1600, 600 Jefferson Street, Lafayette, LA, 70501, US

(21) Appl. No.: 11/499,400

(22) Filed: Aug. 4, 2006

(51) Int. Cl. A01K 5/02

(52) U.S. Cl. 119/51.11

(57) ABSTRACT

An automatic animal feeder has a food hopper connected to a feeding trough. Bulk animal food loaded into the hopper transfers into the feeding trough. A lid covers the feeding trough, preventing access to the animal food. An automated drive mechanism having a timer opens the lid, thereby allowing access to the animal food in the feeding trough, at pre-set intervals. The automatic animal feeder can be used to train wild game to feed during certain desired periods, such as daylight hours.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention pertains to a method and apparatus for automatically feeding game, such as wild game. More particularly, the present invention pertains to an apparatus for selectively making food available to game in accordance with a desired schedule.

2. Description of the Prior Art

Automatic feeders are known in the art. However, existing prior art automatic feeders do not allow access to food only during certain pre-determined periods. Rather, existing prior art feeders typically broadcast or spread food according to an established schedule that is usually programmed in advance by an operator. If the food which has been broadcast or spread by the feeder is not eaten, the food typically stays in the general vicinity of the feeder. Such uneaten food will frequently remain accessible to animals even when the prior art automatic feeder is not actively dispersing food. As a result, existing prior art automatic feeders do not effectively “train” animals to return to such feeders only at a specific predetermined time(s) when food is available.

Thus, there is a need for an automatic feeder that provides animals, such as wild game, access to food only during certain pre-selected periods. The food should be made available, but should not be dispersed or broadcast, so that any uneaten food will remain accessible to such game only during desired feeding periods.

### SUMMARY OF THE INVENTION

The present invention is an automatic feeder that allows animals to feed, such as wild game, only during certain pre-determined periods of the day or night. In one embodiment, the automatic feeder of the present invention comprises a container having a substantially vertical hopper connected to, and in open communication with, a substantially horizontal feeding trough having an upper opening. Animal food including, but not necessarily limited to, corn, grain and/or pelletized nutritional mix, is loaded into said substantially vertical hopper. The animal food transfers from said feed hopper into said feeding trough.

A substantially planar cover is slidably disposed over said feeding trough and covers the upper opening of said feeding trough. When said cover is retracted, the upper opening to the feeding trough (and any food situated therein) is exposed, allowing animals such as wild game to access such food situated within the feeding trough. However, when the cover is closed, said cover prevents animals from accessing the feeding trough and, more particularly, the food contained therein.

A drive mechanism having a timer is connected to said slidable cover. The timer can be programmed to actuate the drive mechanism and open the cover at pre-determined times that can be set by an operator. The timer can also be set to actuate the drive mechanism and close the cover at some time thereafter. In the preferred embodiment, the cover can be set to open and close multiple times, at pre-determined intervals, during each twenty-four hour period. Alternatively, an optical sensor or other similar device can be utilized to limit opening of the cover to certain daylight hours.

In an alternative embodiment of the invention, said container comprises a substantially horizontal trough having a base, a plurality of wall members and an upper opening. A hinged lid covers the upper opening of said container. A drive mechanism having a first end and a second end is mounted to said container and said lid. In the preferred embodiment, the first end of said drive mechanism is pivotally mounted to the under-side of the lid, while the second of said drive mechanism is pivotally mounted to the trough. Actuation of the drive mechanism causes the lid to open and close, as desired, to permit access to the upper opening of the trough and any food contained within said trough.

A timer can be used to program actuation of the drive mechanism and open the hinged lid at pre-determined times. Similarly, the timer can also be set to close the hinged lid at some point thereafter. In the preferred embodiment, the cover can be set to open and close multiple times, at pre-determined intervals, during each twenty-four hour period. Alternatively, an optical sensor or other similar device can be utilized to limit opening of the hinged lid to certain daylight hours.

### BRIEF DESCRIPTION OF THE DRAWINGS

FIG. 1 depicts a perspective view of one embodiment of the automatic feeder of the present invention.

FIG. 2 depicts a side sectional view of one embodiment of the automatic feeder of the present invention.

FIG. 3 depicts a detailed view of a highlighted portion of one embodiment of the automatic feeder of the present invention.

FIG. 4 depicts an overhead perspective view of an alternative embodiment of the automatic feeder of the present invention.

FIG. 5 depicts a side cut-away view of an alternative embodiment of the automatic feeder of the present invention.

### DETAILED DESCRIPTION OF THE PRESENT INVENTION

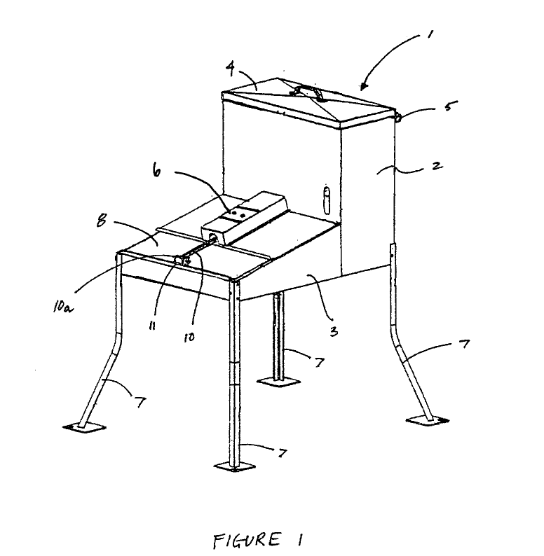

FIG. 1 depicts an overhead perspective view of a preferred embodiment of one embodiment of the automatic feeder 1 of the present invention. Automatic feeder 1 comprises substantially upright food hopper 2. Food hopper 2 is connected to, and in communication with, substantially horizontal feeding trough 3. Feeding trough 3 defines a containment structure having an opening along a portion of its upper surface. In the preferred embodiment, hopper 2 is substantially upright; however, it is to be observed that hopper 2 can take any number of different shapes or configurations, so long as it serves as a storage container for food. Animal food, such as corn, grain, pelletized meal and/or the like, can be loaded into hopper 2 through an opening at the top of hopper 2 (not shown in FIG. 1) and allowed to gravity-transfer into feeding trough 3.

Hopper lid 4 can be received on the upper surface of hopper 2, thereby covering the opening at the top of hopper 2, in order to prevent unwanted access to the inside of hopper 2. Said hopper lid 4 can be attached to hopper 2 using hinge(s) 5. Similarly, said hopper lid 4 can be locked in a closed position using any number of different latching mechanisms which are well known to those having ordinary skill in the art. Although it is possible that feeding trough 3 of the present invention can rest directly on the ground or some other surface, in the preferred embodiment automatic feeder 1 of the present invention is mounted on support legs 7. In the preferred embodiment, feeding trough 3 also has drain holes (not shown in FIG. 1) disposed along its base to allow rain-water or other moisture to drain out of feeding trough 3.

Substantially planar trough cover 8 is slidably disposed over the top of feeding trough 3, thereby covering an opening at the upper surface of said feeding trough 3. In the preferred embodiment, linear actuator 9 (not shown in FIG. 1) having drive rod 10 is mounted to the upper surface of feeding trough 3. Specifically, outer end 10a of drive rod 10 is attached to said slidable cover 8 via mounting bracket 11. When rod 10 is retracted using linear actuator 9, cover 8 is also partially retracted, thereby exposing an opening into feeding trough 3. In such a configuration, animals can access food situated within said feeding trough 3. However, when rod 10 is fully extended, cover 8 blocks the upper opening of feeding trough 3 and prevents access to said feeding trough and the food located therein.

In the preferred embodiment, linear actuator 9 is controlled using computerized timer mechanism 6. Said timer mechanism can be set to function linear actuator 9 and open cover 8, thereby exposing the upper opening to feeding trough 3 at desired times. Similarly, timer 6 can also be set to function linear actuator 9 and close cover 8 at some later time thereafter. In the preferred embodiment, more than one set of times can be programmed for linear actuator to operate and, thus, for cover 8 to open and close, during each twenty-four hour period.

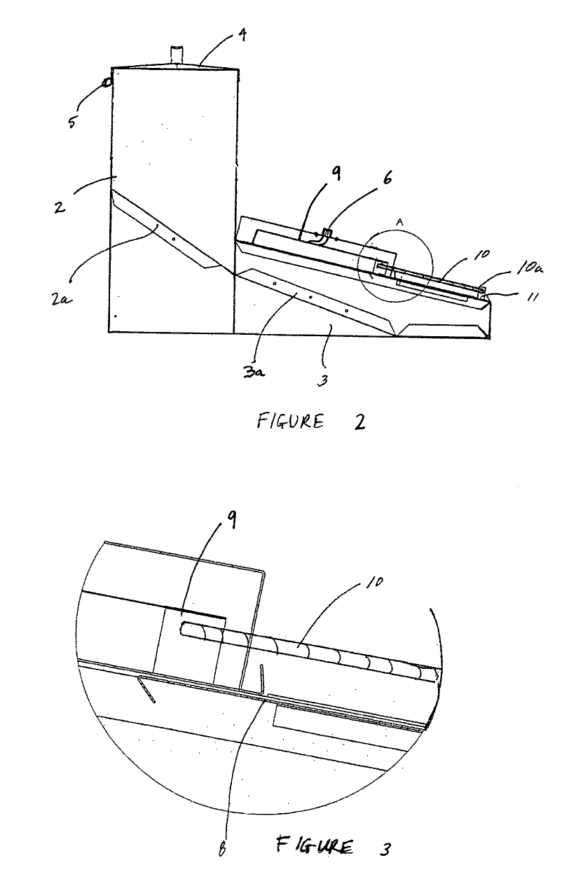

Referring to FIG. 2, substantially horizontal feeding trough 3 is mounted on support legs 7. Upright food hopper 2 is disposed at one end of feeding trough 3, and is in communication with said feeding trough 3. Feeding trough 3 defines a containment structure having an opening along a portion of its upper surface. Animal food, such as corn, grain, pelletized meal and/or the like, can be loaded into hopper 2 through an opening at the top of hopper 2 and allowed to gravity-transfer into feeding trough 3. Upright food hopper 2 has sloped base 2a, while feeding trough 3 has sloped base 3a. Sloped bases 2a and 3a permit such animal food to gravity feed toward the forward portion of said feeding trough 3.

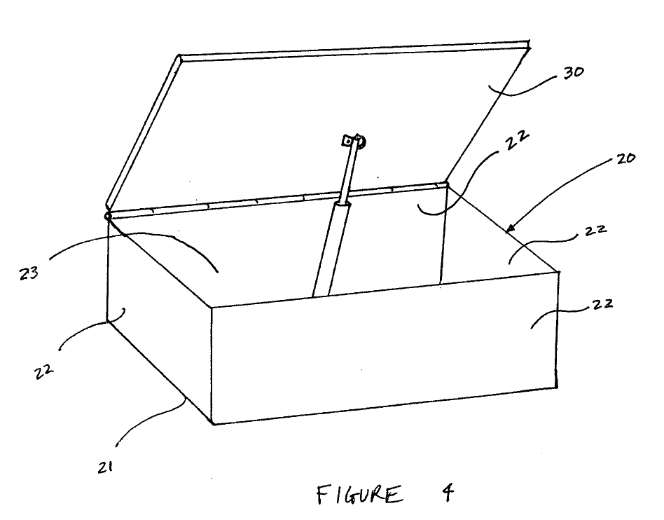

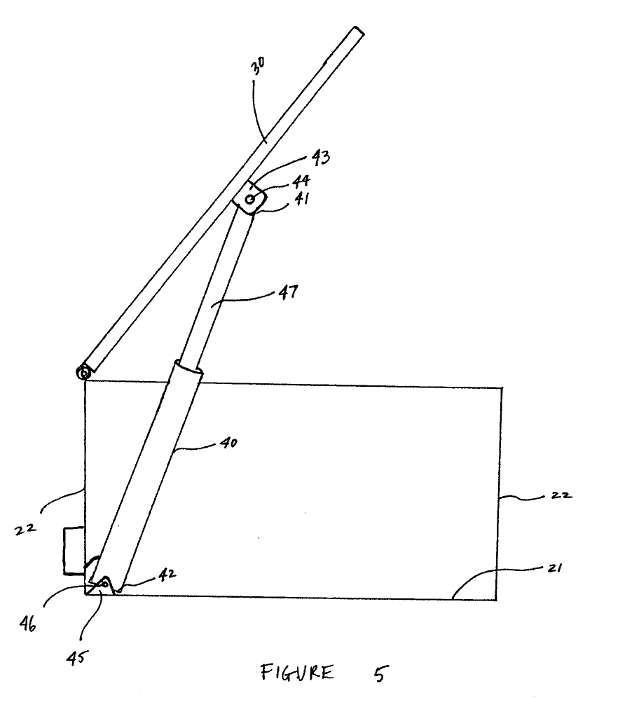

Referring to FIG. 3, substantially planar trough cover 8 is slidably disposed over the top of feeding trough 3, thereby covering an opening at the upper surface of said feeding trough 3. In the preferred embodiment, linear actuator 9 having drive rod 10 is mounted to the upper surface of feeding trough 3. Specifically, outer end 10a of drive rod 10 is attached to mounting bracket 11 on said slidable cover 8. FIG. 4 depicts a detailed view of trough cover 8, linear actuator 9 and drive rod 10. When rod 10 is retracted using linear actuator 9, cover 8 is also partially retracted, thereby exposing an opening into feeding trough 3. In such a configuration, an animal can access food situated within said feeding trough 3. However, when rod 10 is fully extended, cover 8 blocks the upper opening of feeding trough 3 and prevents access to said feeding trough and the food located therein.

FIG. 4 depicts an alternative embodiment of the automatic feeder of the present invention defining a substantially horizontal trough 20 having base 21, a plurality of substantially upright wall members 22 and an upper opening 23. Lid 30 covers upper opening 23 of said trough. Hinge 31 connects lid 30 to a substantially upright wall member 22, thereby allowing lid 30 to open and close over upper opening 23 of trough 20.

Referring to FIG. 5, linear actuator 40 has drive rod 47 which can be extended or retracted by linear actuator 40. Linear actuator 40 has first end 41 mounted to lid 30, and second end 42 mounted to trough 20. In the preferred embodiment, first end 41 of linear actuator 40 is pivotally mounted to the underside of lid 30 via clevis bracket 43 and pivot pin 44, while second end 42 of linear actuator 40 is pivotally mounted to base 21 via clevis bracket 45 and pivot pin 46. Actuation of linear actuator 40 causes hinged lid 30 to open and close, as desired. When lid 30 is opened, animals (such as, for example, wild game) have access to the upper opening 23 of trough 20 and any food contained within said trough. Conversely, when lid 30 is closed, animals are prevented from accessing the inside of trough 20 and any food contained therein.

When rod 47 is extended using linear actuator 40, hinged lid 30 is open, thereby exposing upper opening 23 of trough 20. In such a configuration, an animal can access food situated within said trough 20. However, when rod 47 is retracted, lid 30 covers upper opening 23 of trough 20, thereby preventing access to trough 20 and any food located therein.

It is to be observed that the automatic feeder of the present invention can be used to feed wild animals (including, but not limited to, deer) at certain desired times of the day or night. Such times can be adjusted, as desired. In this manner, it is possible to effectively train animals to venture out for food at certain predetermined times. By way of example, but not limitation, it is possible to train animals that normally feed only after dark to venture out for food during daylight hours. Notwithstanding the foregoing, it is to be observed that the automatic feeder of the present invention is not limited to use with wild animals. The feeder of the present invention may be used with farm animals, domestic animals and/or other animals that do not live in the wild.

The above disclosed invention has a number of particular features which should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of feeding animals comprising:
a. loading food in a container;
b. placing said container in an area that is accessible to animals;
c. opening said container during daylight hours; and
d. closing said container during non-daylight hours.

2. A feeder comprising:
a. a container having a hinged lid;
b. means for opening said lid during daylight hours and closing said lid during non-daylight hours.

3. The feeder of claim 2, wherein said means for opening and closing said hinged lid comprises:
a. a linear actuator having a first end and a second, wherein said first end is connected to said container and said second end is connected to said lid; and
b. a timer controlling the operation of said linear actuator.

4. The feeder of claim 2, wherein said means for automatically opening and closing said hinged lid comprises:
a. a linear actuator having a first end and a second, wherein said first end is connected to said container and said second end is connected to said lid; and
b. an optical sensor controlling the operation of said linear actuator.

5. A feeder comprising:
a. a container defining a substantially horizontal trough section and a substantially vertical hopper section;
b. a cover slidably disposed over said substantially horizontal trough section;
c. a linear actuator having a first end and a second end, wherein said first end is connected to said cover and said second end is connected to said container; and
d. means for opening said lid during daylight hours and closing said lid during non-daylight hours.

6. The feeder of claim 5, wherein said means for opening said lid during daylight hours and closing said lid during non-daylight hours comprises an optical sensor controlling the operation of said linear actuator.

7. The feeder of claim 5, wherein said means for opening said lid during daylight hours and closing said lid during non-daylight hours comprises a timer controlling the operation of said linear actuator.

7. The feeder of claim 5, wherein said base has a slanted bottom surface.
